(19) United States
(12) Patent Application Publication
(10) Pub. No.: US 2021/0264924 A1
(43) Pub. Date: Aug. 26, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Yoshimi UEZU, Kanagawa (JP)

(73) Assignee: FUJIFILM Business Innovation Corp., Tokyo (JP)

(21) Appl. No.: 17/022,124

(22) Filed: Sep. 16, 2020

(30) Foreign Application Priority Data
Feb. 20, 2020 (JP) 2020-027465

(51) Int. Cl. G10L 17/06

(52) U.S. Cl. CPC G10L 17/06

(57) ABSTRACT

An information processing apparatus includes a processor configured to show, to a first person among plural persons who make speeches and actions via a network, a degree of progress of a relationship between a second person and a third person. The degree of progress is based on speeches and actions between the second person and the third person. The second person matches the first person. The third person matches the second person.

### CROSS-REFERENCE TO RELATED APPLICATIONS

This application is based on and claims priority under 35 USC 119 from Japanese Patent Application No. 2020-027465 filed Feb. 20, 2020.

### BACKGROUND

### (i) Technical Field

The present disclosure relates to an information processing apparatus and a non-transitory computer readable medium.

### (ii) Related Art

Japanese Unexamined Patent Application Publication No. 2002-203034 discloses a marriage information providing system. The marriage information providing system of Japanese Unexamined Patent Application Publication No. 2002-203034 includes an inputter, a matchmaker, and a transmitter. The inputter creates a home page on the Internet and receives, on the home page, pieces of detailed information about men and women who seek for their partners for marriage. The inputter receives a user's input about a detailed condition required for an expected partner. Data on the condition is stored in a storage. The matchmaker finds a partner who satisfies the condition in the data. The transmitter transmits electronic mails to the user and the partner found through the matchmaking to show their personal information. In the marriage information providing system of Japanese Unexamined Patent Application Publication No. 2002-203034, the user and the partner are allowed to exchange electronic mails via the home page alone. Thus, privacy of the user and the partner is protected.

### SUMMARY

Aspects of non-limiting embodiments of the present disclosure relate to the following circumstances. In a network matchmaking system, a first person may find a match with a second person, and the second person may find a match with a third person. In this case, it is difficult for the first person to develop a relationship with the second person in consideration of the progress of a relationship between the second person and the third person.

It is desirable to provide an information processing apparatus and a non-transitory computer readable medium storing an information processing program, in which a first person may develop a relationship with a second person who matches the first person in consideration of the progress of a relationship between the second person and a third person who matches the second person.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to show, to a first person among a plurality of persons who make speeches and actions via a network, a degree of progress of a relationship between a second person and a third person. The degree of progress is based on speeches and actions between the second person and the third person. The second person matches the first person. The third person matches the second person.

### BRIEF DESCRIPTION OF THE DRAWINGS

An exemplary embodiment of the present disclosure will be described in detail based on the following figures, wherein:

FIG. 1 illustrates the configuration of a matchmaking system of an exemplary embodiment;

FIG. 2 illustrates activities of members who use the matchmaking system of the exemplary embodiment;

FIG. 3 illustrates the configuration of a server of the exemplary embodiment;

FIG. 4 is a functional block diagram of the server of the exemplary embodiment;

FIG. 5 illustrates details of profile information of the exemplary embodiment;

FIG. 6 illustrates details of a conversation history of the exemplary embodiment;

FIG. 7 illustrates details of word information of the exemplary embodiment;

FIG. 8 is a flowchart illustrating update of the conversation history in the matchmaking system of the exemplary embodiment;

FIG. 9 is a flowchart illustrating analysis of the conversation history in the matchmaking system of the exemplary embodiment;

FIG. 10 illustrates relationships among the members in the exemplary embodiment;

FIG. 11 illustrates analysis results (counts and frequencies of conversations) of the exemplary embodiment;

FIG. 12 illustrates analysis results (time periods of conversations) of the exemplary embodiment;

FIG. 13A is a graph illustrating analysis results (intimacies with a first member) of the exemplary embodiment;

FIG. 13B illustrates relationships of the analysis results (intimacies with the first member) of the exemplary embodiment;

FIG. 14A is a graph illustrating analysis results (intimacies with a second member) of the exemplary embodiment;

FIG. 14B illustrates relationships of the analysis results (intimacies with the second member) of the exemplary embodiment; and

FIG. 15 illustrates details of advice of the exemplary embodiment.

### DETAILED DESCRIPTION

### Exemplary Embodiment

Description is made of a matchmaking system including an information processing apparatus according to an exemplary embodiment of the present disclosure.

### Configuration of Exemplary Embodiment

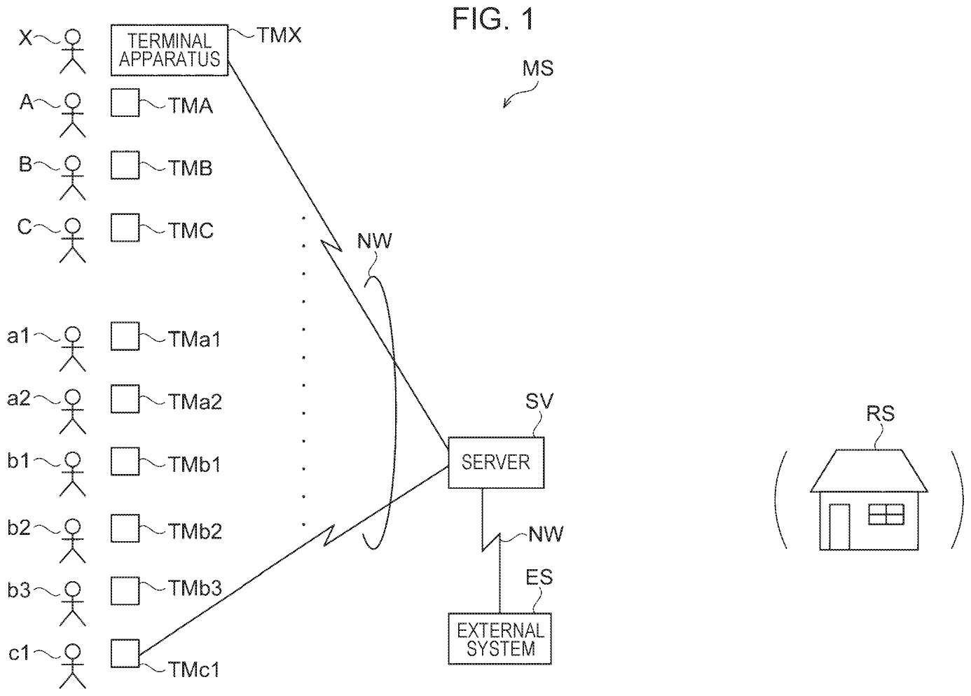

FIG. 1 illustrates the configuration of a matchmaking system MS of the exemplary embodiment. The configuration of the matchmaking system MS of the exemplary embodiment is described below with reference to FIG. 1.

As illustrated in FIG. 1, the matchmaking system MS of the exemplary embodiment basically includes a server SV and a plurality of terminal apparatuses TMX, TMA, TMB . . . to be used by a plurality of users X, A, B . . . .

The “server SV” is an example of the “information processing apparatus”.

For convenience of the description, the terminal apparatuses TMX, TMA, TMB . . . may hereinafter be referred to collectively as “terminal apparatuses TM”.

Examples of the terminal apparatus TM include a smartphone and a notebook computer. The terminal apparatus TM is connectable to the server SV via a network NW (e.g., a wireless or wired network).

As illustrated in FIG. 1, the matchmaking system MS is connectable to an external system ES (e.g., a social networking service (SNS)) via the network NW.

For example, a restaurant RS or a cafe exists apart from the matchmaking system MS.

For example, the matchmaking system MS helps a man and a woman to find their partners for marriage. The plurality of users X, A, B . . . are members of the matchmaking system MS. The plurality of users X, A, B . . . establish connection between the terminal apparatuses TMX, TMA, TMB . . . and the server SV to use the service for finding partners with the aid of the server SV.

<Activities of Members>

The plurality of users X, A, B . . . are hereinafter referred to as a plurality of members X, A, B . . . .

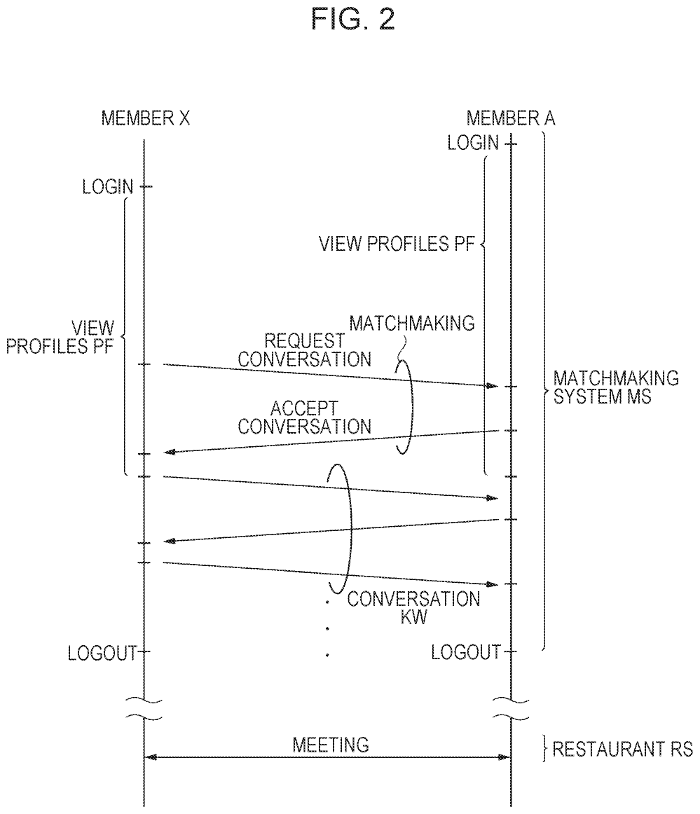

FIG. 2 illustrates activities of the members who use the matchmaking system MS of the exemplary embodiment.

As illustrated in FIG. 2, for example, two members X and A first log into the server SV by using the terminal apparatus TMX and the terminal apparatus TMA, respectively.

As illustrated in FIG. 2, the members X and A then view profiles PF (described later with reference to FIG. 5) provided by the server SV. The members X and A view profiles PF of members other than the members X and A, respectively. For example, the member X views profiles PF of members other than the member X. Similarly, the member A views profiles PF of members other than the member A.

The profile PF described above with reference to FIG. 2 is a generic term of profiles PF1, PF2, PF3 . . . in FIG. 5.

For example, the member X who wants to have a conversation (so-called chat) with the member A sends a “request for conversation” to the member A via the server SV.

In response to the “request for conversation” from the member X, the member A sends an “acceptance of conversation” to the member X via the server SV when the member A wants to have a conversation with the member X.

Thus, the members X and A may enjoy a conversation KW by using their terminal apparatuses TMX and TMA in the matchmaking system MS.

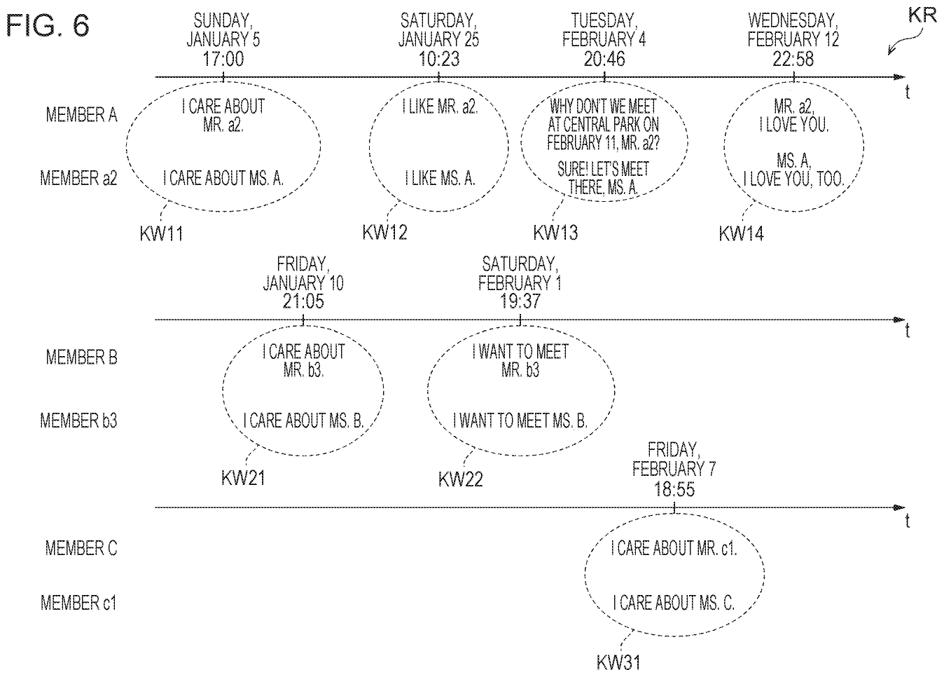

The conversation KW is a generic term of conversations KW11 to KW31 described later with reference to FIG. 6.

After the conversation KW, the members X and A log out of the server SV by using their terminal apparatuses TMX and TMA.

By having a plurality of conversations KW in the matchmaking system MS, for example, the members X and A who raise a desire to meet each other express their feelings and make an arrangement for meeting in the conversations KW, and then meet at, for example, the restaurant RS (see FIG. 1). Thus, the members X and A may advance to a dating relationship.

The activities of the members X and A to view profiles PF, have conversations KW, and make arrangements for meeting on the server SV, and to meet each other in actuality are examples of “speech and action”.

<Configuration and Functions of Server SV>

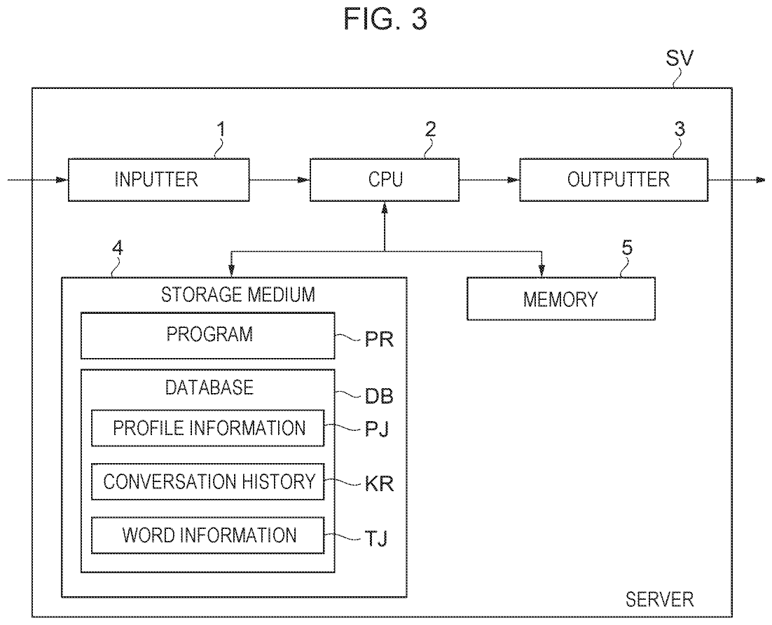

FIG. 3 illustrates the configuration of the server SV of the exemplary embodiment.

As illustrated in FIG. 3, the server SV of the exemplary embodiment includes an inputter 1, a central processing unit (CPU) 2, an outputter 3, a storage medium 4, and a memory 5.

Examples of the inputter 1 include a keyboard, a mouse, and a touch panel. The CPU 2 is an example of a processor and is a core of a known computer that operates hardware based on software. Examples of the outputter 3 include a printer and a liquid crystal monitor. Examples of the storage medium 4 include a hard disk drive (HDD), a solid state drive (SSD), and a read only memory (ROM). Examples of the memory 5 include a dynamic random access memory (DRAM) and a static random access memory (SRAM).

The storage medium 4 stores a program PR and a database DB.

The program PR is a group of commands that describe details of processes to be executed by the server SV.

As illustrated in FIG. 3, the database DB includes profile information PJ, a conversation history KR, and word information TJ. The profile information PJ, the conversation history KR, and the word information TJ are described later.

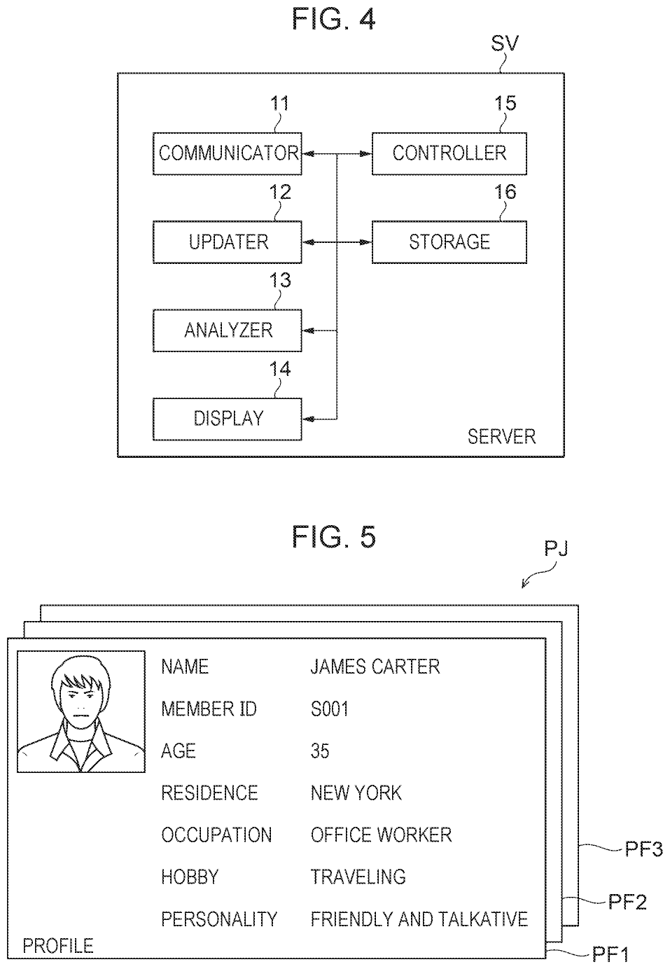

FIG. 4 is a functional block diagram of the server SV of the exemplary embodiment.

As illustrated in FIG. 4, the server SV includes a communicator 11, an updater 12, an analyzer 13, a display 14, a controller 15, and a storage 16.

The relationship between the hardware configuration and the functional configuration of the server SV is as follows. On hardware, the CPU 2 executes the program PR stored in the storage medium 4 (that implements a part of the function of the storage 16) by using the memory 5 (that implements another part of the function of the storage 16) and controls, as the controller 15, operations of the inputter 1 and the outputter 3 as necessary, thereby implementing the functions of the communicator 11, the updater 12, the analyzer 13, and the display 14. The functions of the individual parts are described later.

<Configuration and Functions of Terminal Apparatus TM>

Referring back to FIG. 1, examples of the terminal apparatus TM include a smartphone and a notebook computer. The terminal apparatus TM has a communication function, an input function, and an output function.

For example, the terminal apparatus TM implements the communication function by a network unit (not illustrated). For example, the terminal apparatus TMX of the member X exchanges messages in the conversation KW between the members X and A with the server SV by using the communication function.

For example, the terminal apparatus TM implements the input function by a keyboard, a mouse, and a voice recognition unit (not illustrated). For example, the terminal apparatus TMX receives, from the member X, login information (e.g., an ID number or password) and a message from the member X in the conversation KW (e.g., “I want to know anything about Ms. A.”).

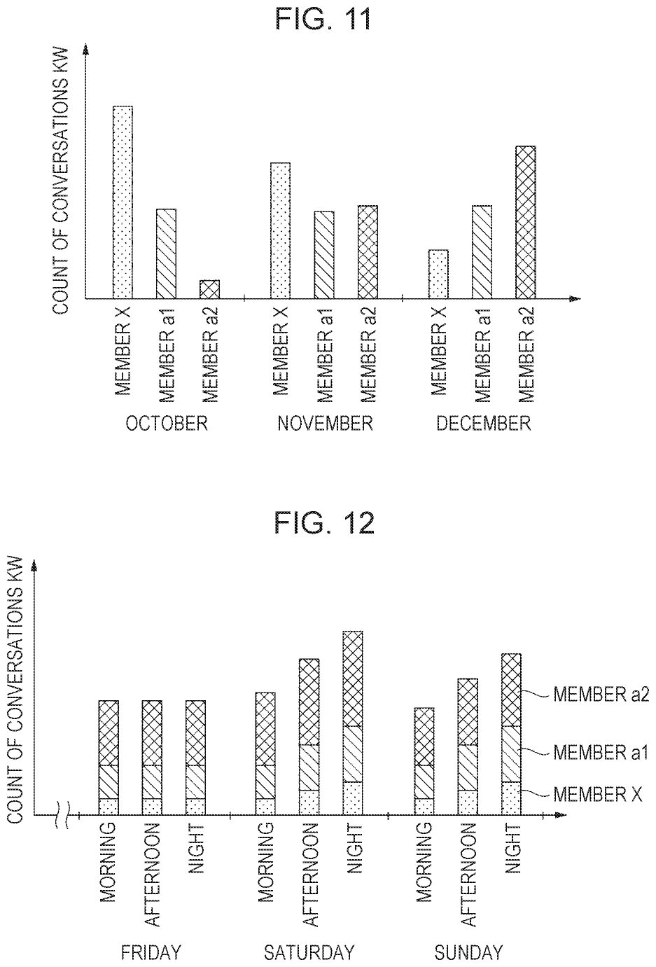

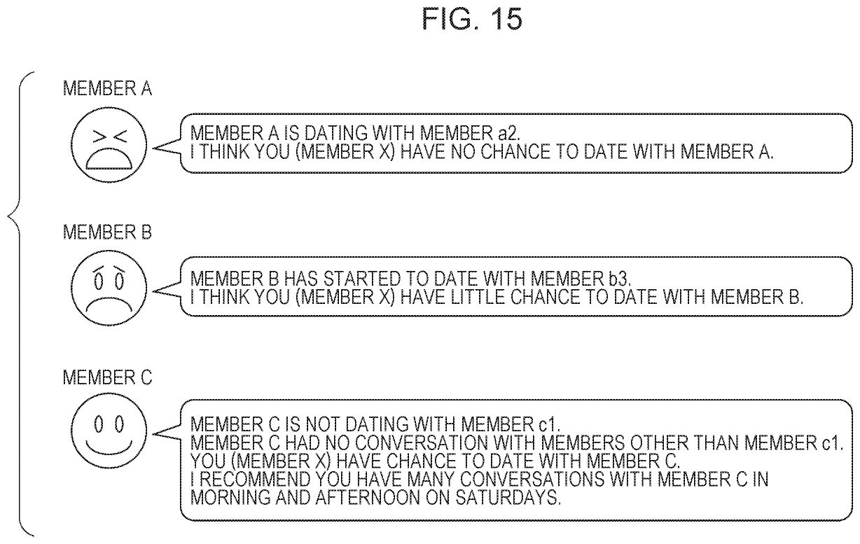

For example, the terminal apparatus TM implements the output function by a liquid crystal panel and a loudspeaker (not illustrated). For example, the terminal apparatus TMX displays, for the member X, a message from the member A in the conversation KW (e.g., “I want to know anything about Mr. X.”), results of analysis of the conversation history KR (see FIG. 6) (described later with reference to FIG. 11 to FIG. 14B), and advice based on the analysis results (described later with reference to FIG. 15).

<Details of Profile Information PJ>

FIG. 5 illustrates details of the profile information PJ of the exemplary embodiment.

As illustrated in FIG. 5, the profile information PJ of the exemplary embodiment (see FIG. 3 as well) contains profiles PF, that is, the plurality of profiles PF1, PF2, PF3 . . . .

For example, the profile PF1 illustrated in FIG. 5 shows a name “James Carter”, a picture, a member ID “S001”, an age “35”, a residence “New York”, an occupation “office worker”, a hobby “traveling”, and a personality “friendly and talkative”.

<Details of Conversation History KR>

FIG. 6 illustrates details of the conversation history KR of the exemplary embodiment.

As illustrated in FIG. 6, the conversation history KR (see FIG. 3 as well) contains a plurality of conversations KW between the members. For example, the conversation history KR contains a plurality of time-series conversations KW11, KW12, KW13, and KW14 between the member A and a member a2. For example, the conversation history KR further contains a plurality of time-series conversations KW21, KW22, and KW33 between the member B and a member b3. For example, the conversation history KR further contains a single conversation KW31 between a member C and a member cl.

For example, the conversation KW12 between the member A and the member a2 in the conversation history KR shows a message “I like Mr. a2.” from the member A and a message “I like Ms. A.” from the member a2 at 10:23 on Saturday, January 25.

The conversation history KR contains other conversations KW in addition to the conversations between the member A and the member a2, the conversations between the member B and the member b3, and the conversation between the member C and the member cl. For example, the conversation history KR contains conversations KW between the member A and the member X who matches the member A (described later with reference to FIG. 11 and FIG. 12), and conversations KW between the member A and a member a1 who matches the member A (described later with reference to FIG. 11 and FIG. 12).

<Details of Word Information TJ>

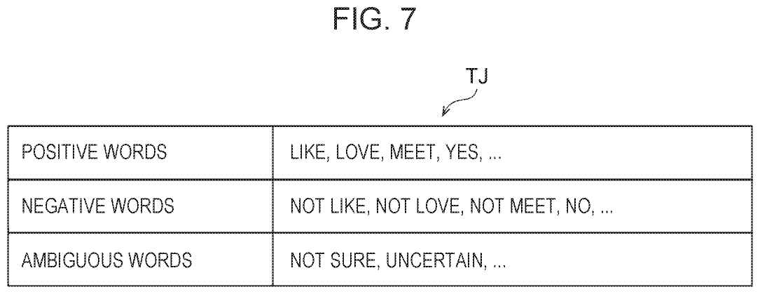

FIG. 7 illustrates details of the word information TJ of the exemplary embodiment.

The word information TJ (see FIG. 3 as well) is used for analyzing details of the conversations KW in the conversation history KR (see FIG. 6). As illustrated in FIG. 7, the word information TJ contains positive words, negative words, and ambiguous words.

For example, the CPU 2 of the server SV (see FIG. 3) analyzes the conversation KW12 between the member A and the member a2 (see FIG. 6) as follows. The word “like” in the message “I like Mr. a2.” from the member A matches a positive word “like”. Thus, the message “I like Mr. a2.” from the member A indicates that the member A has a positive feeling, that is, an affection for the member a2.

Similarly, the CPU 2 of the server SV analyzes the conversation KW12 as follows. The word “like” in the message “I like Ms. A.” from the member a2 matches the positive word “like”. Thus, the message “I like Ms. A.” from the member a2 indicates that the member a2 has a positive feeling, that is, an affection for the member A.

The CPU 2 of the server SV focuses on the situations in which “the members X, A, B . . . meet at the restaurant RS (see FIG. 1)” (see FIG. 2). For example, the CPU 2 presumes that “the members A and a2 will meet in the near future” based on details of the conversation KW13 between the member A and the member a2 (see FIG. 6), and that “the members A and a2 have actually met” based on details of the conversation KW14 between the member A and the member a2 (see FIG. 6).

The CPU 2 serving as the communicator 11 (see FIG. 4) may acquire positional information of the member A (including date information) and positional information of the member a2 (including date information) via the network NW (see FIG. 1) by using Global Positioning System (GPS) functions installed in the terminal apparatus TMA of the member A and a terminal apparatus TMa2 of the member a2. The CPU 2 serving as the communicator 11 may further acquire, from the external system ES such as an SNS (see FIG. 1), external information containing posted speeches, actions, and pictures of the member A and the member a2. The CPU 2 that refers to the positional information of the member A, the positional information of the member a2, and the external information of the member A and the member a2 has an increased accuracy of presumption as to whether the member A and the member a2 have actually met.

### Operations of Exemplary Embodiment

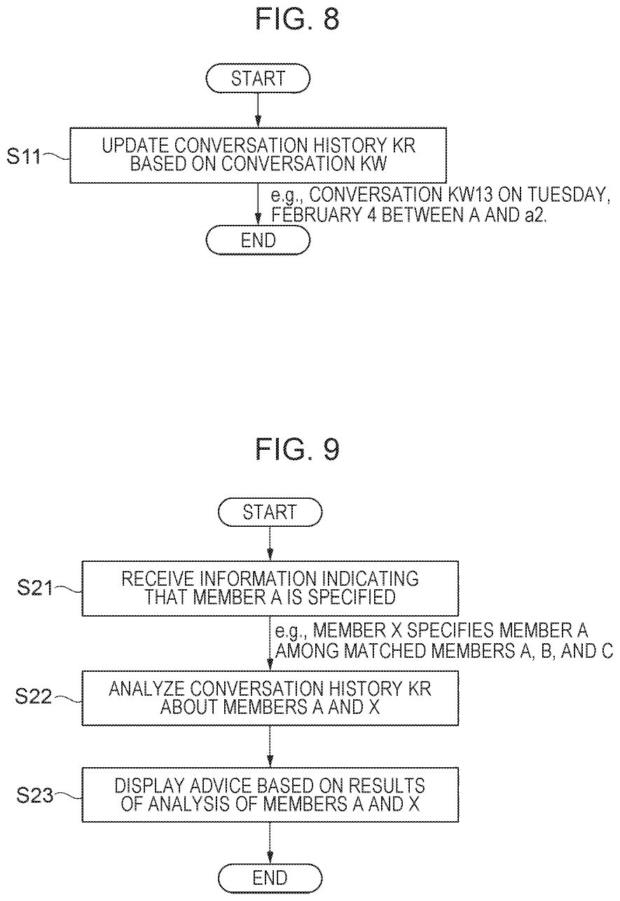

FIG. 8 is a flowchart illustrating update of the conversation history KR in the matchmaking system MS of the exemplary embodiment.

FIG. 9 is a flowchart illustrating analysis of the conversation history KR in the matchmaking system MS of the exemplary embodiment.

Operations of the matchmaking system MS of the exemplary embodiment are described below with reference to FIG. 8 and FIG. 9.

To facilitate description and understanding of the operations of the matchmaking system MS, relationships among the members are presupposed below.

<Relationships Among Members>

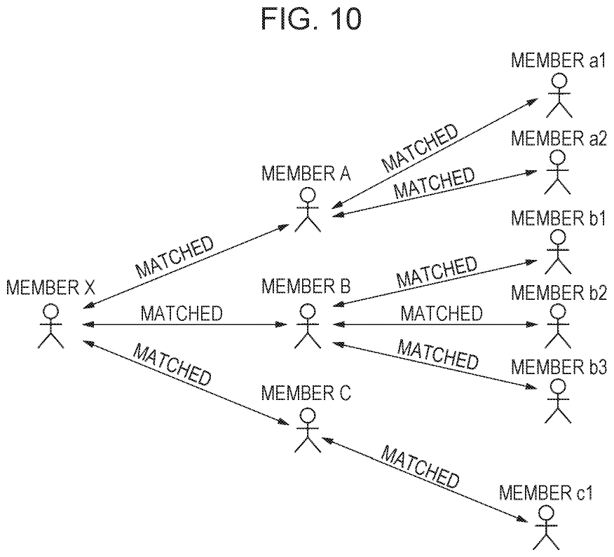

FIG. 10 illustrates relationships among the members in the exemplary embodiment.

The members X, A, B, C . . . (see FIG. 1 as well) have the relationships illustrated in FIG. 10. Details of the relationships are as follows.

The member X matches the member A, the member B, and the member C (see FIG. 2).

The member A matches the member X, the member a1, and the member a2.

The member B matches the member X, a member b1, a member b2, and the member b3.

The member C matches the member X and the member cl. <Update of Conversation History KR>

Update of the conversation history KR is described with reference to FIG. 8.

In Step S11, for example, the member A and the member a2 have the conversation KW13 at 20:46 on Tuesday, February 4 as illustrated in FIG. 6 via the server SV by using the terminal apparatus TMA and the terminal apparatus TMa2, respectively. More specifically, the member A sends a message “Why don't we meet at Central Park on February 11, Mr. a2?” and the member a2 sends a message “Sure! Let's meet there, Ms. A.”

In response to the conversation KW13, the CPU 2 of the server SV (see FIG. 3) serving as the updater 12 (see FIG. 4) stores the conversation KW13 in the storage medium 4 (see FIG. 3). In other words, the CPU 2 updates the conversation history KR by adding the conversation KW13 to the storage medium 4 that stores the conversations KW11 and KW12 (see FIG. 6) before Tuesday, February 4.

Similarly, the CPU 2 updates conversations KW between the other members. For example, the CPU 2 updates the conversation history KR by storing the conversations KW21 and KW22 between the member B and the member b3 (see FIG. 6) in the storage medium 4.

<Analysis of Conversation History KR>

Analysis of the conversation history KR is described with reference to FIG. 9.

In Step S21, for example, the member X operates the terminal apparatus TMX to transmit, to the server SV, information indicating that the member A is specified among the members A, B, and C who match the member X (see FIG. 10). In other words, the CPU 2 of the server SV serving as the communicator 11 (see FIG. 4) receives the information indicating that “the member A is specified by the member X” from the terminal apparatus TMX.

In response to the reception of the information indicating that the member A is specified in Step S21, the CPU 2 of the server SV analyzes, in Step S22, the conversation history KR about the specified member A and about the member X who has specified the member A.

More specifically, the CPU 2 analyzes, for the member A, the conversations KW between the member A and the member X (not illustrated), the conversations KW between the member A and the member a1 (not illustrated), and the conversations KW11 to KW14 between the member A and the member a2 (see FIG. 6).

The CPU 2 further analyzes, for the member X, conversations KW between the member X and the member B (not illustrated) and conversations KW between the member X and the member C (not illustrated) in addition to the conversations KW between the member X and the member A. <Analysis Results: Counts and Frequencies of Conversations KW with “Member A” and Count of Persons Involved in Conversations KW>

FIG. 11 illustrates analysis results (counts and frequencies of conversations KW and count of persons involved in the conversations KW) of the exemplary embodiment.

The CPU 2 serving as the analyzer 13 analyzes the conversation history KR between the member A and each of the three members X, a1, and a2 who match the member A (partially illustrated in FIG. 6). More specifically, the CPU 2 performs analysis based on counts and dates of conversations KW with the member A in the conversation history KR. In the example of FIG. 11, the CPU 2 grasps the count of members who had conversations KW with the member A in last October, November, and December, the counts of conversations KW between the member A and each of the members X, a1, and a2, and the frequencies of the conversations KW (those pieces of data are examples of “degrees of progress of relationships” between the member A and the members X, a1, and a2).

In FIG. 11, the pieces of data about the conversations KW indicate that the count of the conversations KW between the member A and the member X gradually decreases in the last three months, the count of the conversations KW between the member A and the member a1 hardly changes in the last three months, and the count of the conversations KW between the member A and the member a2 gradually increases in the last three months.

<Analysis Results: Time Periods of Conversations KW with “Member A”>

FIG. 12 illustrates analysis results (time periods of conversations KW) of the exemplary embodiment.

The CPU 2 serving as the analyzer 13 analyzes the conversations KW between the member A and each of the members X, a1, and a2 in the conversation history KR (see FIG. 6) particularly about days of the week and time periods of the conversations KW. The CPU 2 grasps days of the week when the members X, a1, and a2 had the conversations KW with the member A, and time periods during which the conversations KW were held (those pieces of data are examples of the “degrees of progress of relationships” between the member A and the members X, a1, and a2).

In FIG. 12, the pieces of data about the conversations KW indicate that the member A had many conversations KW with each of the members X, a1, and a2 particularly on Saturday night among the days of the week from Monday to Sunday.

<Analysis Results: Intimacies with “Member A”>

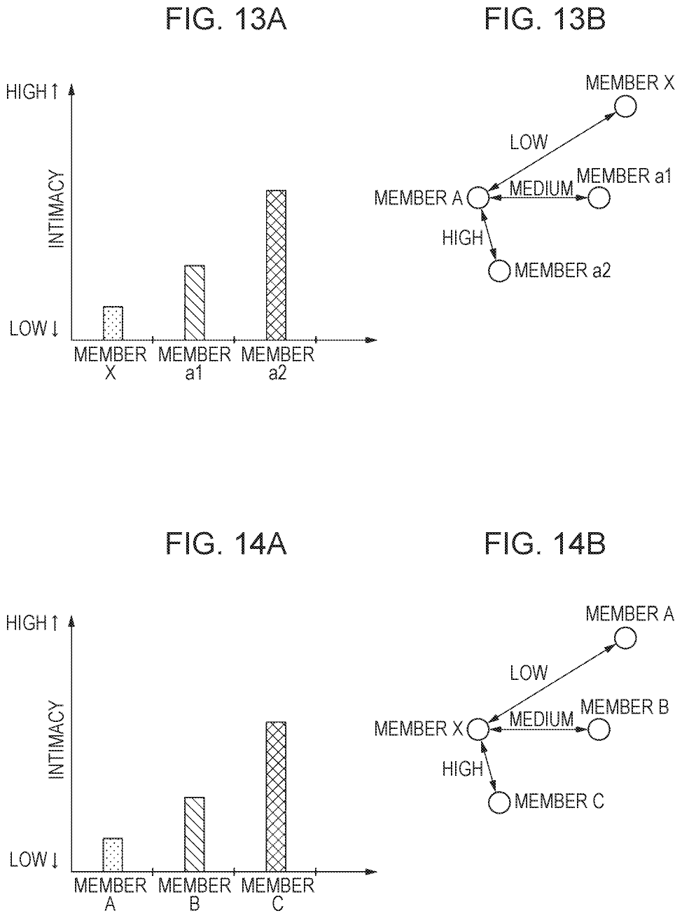

FIG. 13A is a graph illustrating analysis results (intimacies with the member A) of the exemplary embodiment.

FIG. 13B illustrates relationships of the analysis results (intimacies with the member A) of the exemplary embodiment.

The CPU 2 serving as the analyzer 13 analyzes intimacies between the member A and the members X, a1, and a2 based on the counts and frequencies of the conversations KW and the count of persons involved in the conversations KW (see FIG. 11), the time periods during which the conversations KW were held (see FIG. 12), and the details of the conversations KW (e.g., “positive conversations” (see FIG. 7)) in the conversation history KR (see FIG. 6). <Intimacies Based on Counts and Frequencies of Conversations KW, Count of Persons Involved in Conversations KW, and Time Periods during Which Conversations KW Were Held>

For example, the CPU 2 makes the following determination based on the counts and frequencies of the conversations KW and the count of persons involved in the conversations KW (see FIG. 11) and the time periods during which the conversations KW were held (see FIG. 12).

(1-1) Member X

Based on the fact that the count of the conversations KW between the member A and the member X gradually decreases, the intimacy between the member A and the member X decreases (low intimacy).

(2-1) Member a1

Based on the fact that the count of the conversations KW between the member A and the member a1 does not change, the intimacy between the member A and the member a1 neither increases nor decreases (medium intimacy).

(3-1) Member a2

Based on the fact that the count of the conversations KW between the member A and the member a2 gradually increases, the intimacy between the member A and the member a2 increases (high intimacy).

<Intimacies Based on Details of Conversations KW>

The CPU 2 makes the following determination by analyzing the details of the conversations KW based on the word information TJ (see FIG. 7).

(1-2) Member X

Based on the fact that the count of “positive words” (see FIG. 7) gradually decreases and the count of “negative words” (see FIG. 7) gradually increases in the conversations KW between the member A and the member X (not illustrated), the intimacy between the member A and the member X decreases (low intimacy).

(2-2) Member a1

Based on the fact that “positive words”, “negative words”, and “ambiguous words” (see FIG. 7) are mixed in the conversations KW between the member A and the member a1 (not illustrated), the intimacy between the member A and the member a1 neither increases nor decreases (medium intimacy).

(3-2) Member a2

Based on the fact that the count of “positive words” is large in the conversations KW11, KW12, KW13, and KW14 between the member A and the member a2 (see FIG. 6), the intimacy between the member A and the member a2 increases (high intimacy).

<Conclusions of Intimacies>

The CPU 2 provides the following conclusions based on the determination results (1-1) to (3-2).

(1) Member X

Based on the determination results (1-1) and (1-2), the intimacy between the member A and the member X is “low”.

(2) Member a1

Based on the determination results (2-1) and (2-2), the intimacy between the member A and the member a1 is “medium”.

(3) Member a2

Based on the determination results (3-1) and (3-2), the intimacy between the member A and the member a2 is “high”.

The CPU 2 shows the conclusions (1) to (3) by the lengths of bars in a bar graph as illustrated in FIG. 13A, and by the lengths of arrows as illustrated in FIG. 13B.

FIG. 13A demonstrates that the intimacy increases as the length of the bar in the bar graph increases, and the intimacy decreases as the length of the bar in the bar graph decreases. Contrary to FIG. 13A, FIG. 13B demonstrates that the intimacy increases as the length of the arrow decreases, and the intimacy decreases as the length of the arrow increases.

<Analysis Results: Intimacies with “Member X”>

FIG. 14A is a graph illustrating analysis results (intimacies with the member X) of the exemplary embodiment.

FIG. 14B illustrates relationships of the analysis results (intimacies with the member X) of the exemplary embodiment.

The CPU 2 serving as the analyzer 13 provides the following conclusions of intimacies between the member X and the members A, B, and C similarly to the analysis to obtain the intimacies between the member A and the members X, a1, and a2.

(4) The intimacy between the member X and the member A is “low”.

(5) The intimacy between the member X and the member B is “medium”.

(6) The intimacy between the member X and the member C is “high”.

The CPU 2 shows the conclusions (4) to (6) by the lengths of bars in a bar graph as illustrated in FIG. 14A, and by the lengths of arrows as illustrated in FIG. 14B.

<Analysis Results: Advice>

FIG. 15 illustrates details of advice of the exemplary embodiment.

For example, the CPU 2 of the server SV (see FIG. 3) serving as the analyzer 13 (see FIG. 4) provides the following pieces of advice (example of “candidates for desirable speech or action to be selected”) as illustrated in FIG. 15 based on all the determination results (1-1) to (3-2) and the conclusions (1) to (3) and (4) to (6) about the intimacies.

(Advice 1) Member A

The member A is dating with the member a2. I think you (member X) have no chance to date with the member A.

(Advice 2) Member B

The member B has started to date with the member b3. I think you (member X) have little chance to date with the member B.

(Advice 3) Member C

The member C is not dating with the member cl. The member C had no conversation with members other than the member cl. You (member X) have a chance to date with the member C. I recommend you have many conversations with the member C in the morning and afternoon on Saturdays.

Referring back to FIG. 9, the description continues about the operations of the matchmaking system MS of the exemplary embodiment.

After the conversation history KR about the members A and X (partially illustrated in FIG. 6) is analyzed in Step S22, the CPU 2 of the server SV (see FIG. 3) serving as the communicator 11 and the display 14 (see FIG. 4) causes, in Step S23, the terminal apparatus TMX of the member X to display the results of the analysis of the conversation history KR about the member A and the results of the analysis of the conversation history KR about the member X (see FIG. 11 to FIG. 14B), and the advice (see FIG. 15).

In consideration of the results of the analysis of the conversation history KR about the member A and the results of the analysis of the conversation history KR about the member X (see FIG. 11 to FIG. 148), and the advice obtained based on the analysis results (see FIG. 15), the member X forecasts future progress of the relationships with the members A, B, and C who match the member X. That is, the member X forecasts whether to “meet” or “date with” any member.

### Modified Example 1: Personal Information

It is desirable that the CPU 2 prevent the terminal apparatus TMX from displaying personal information (e.g., details (not illustrated) of names (see FIG. 5) and residences (see FIG. 5)) in information containing the results of the analysis of the conversation history KR about the member A and the results of the analysis of the conversation history KR about the member X (see FIG. 11 to FIG. 14B), and the advice (see FIG. 15). That is, it is desirable that the CPU 2 conceal the personal information.

### Modified Example 2: Privacy Information

It is desirable that the CPU 2 prevent the terminal apparatus TMX from displaying privacy information (e.g., “date”, “person”, and “place” about the hobby “traveling” (see FIG. 5)) in information containing the results of the analysis of the conversation history KR about the member A and the results of the analysis of the conversation history KR about the member X (see FIG. 11 to FIG. 14B), and the advice (see FIG. 15). That is, it is desirable that the CPU 2 conceal the privacy information.

### Modified Example 3: Rearrangement of Pieces of Advice

For example, the CPU 2 may display the pieces of advice (see FIG. 15) in order desirable for the member X during actual selection, instead of displaying the pieces of advice in order of member IDs of the members A, B, and C (not illustrated). Specifically, the CPU 2 may display the advice about the member C in a first field (top) because the advice is positive for the member X, display the advice about the member B in a subsequent field (middle) because the advice is somewhat negative for the member X, and display the advice about the member A in a last field (bottom) because the advice is negative for the member X.

### Modified Example 4: Other Applications of Matchmaking System MS

The matchmaking system MS is also applicable to the following cases in addition to the case where the matchmaking system MS helps a man and a woman to find their partners for marriage. That is, the matchmaking system MS may provide matchmaking between a job seeker and a company that seeks for human resources, or matchmaking between an organization that seeks for students of a cultural center and an applicant for the cultural center.

<Supplementary Description of Processor and Program>

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

In the exemplary embodiment, the program PR may be provided not only by being prestored (preinstalled) in the storage medium 4 but also by being recorded in a recording medium such as a compact disc read only memory (CD-ROM), a digital versatile disc read only memory (DVD-ROM), or a universal serial bus (USB) memory, or by being downloaded from an external apparatus via a network.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
show, to a first person among a plurality of persons who make speeches and actions via a network, a degree of progress of a relationship between a second person and a third person, the degree of progress being based on speeches and actions between the second person and the third person, the second person matching the first person, the third person matching the second person.

2. The information processing apparatus according to claim 1, wherein the processor is configured to conceal, from the first person, personal information and privacy information of the second person and personal information and privacy information of the third person in information containing the degree of progress of the relationship between the second person and the third person.

3. The information processing apparatus according to claim 1, wherein the speeches and actions between the second person and the third person comprise conversations between the second person and the third person via the network.

4. The information processing apparatus according to claim 2, wherein the speeches and actions between the second person and the third person comprise conversations between the second person and the third person via the network.

5. The information processing apparatus according to claim 1, wherein the processor is configured to show, to the first person, a degree of opportunity of conversations between the second person and the third person.

6. The information processing apparatus according to claim 2, wherein the processor is configured to show, to the first person, a degree of opportunity of conversations between the second person and the third person.

7. The information processing apparatus according to claim 3, wherein the processor is configured to show, to the first person, a degree of opportunity of the conversations between the second person and the third person.

8. The information processing apparatus according to claim 4, wherein the processor is configured to show, to the first person, a degree of opportunity of the conversations between the second person and the third person.

9. The information processing apparatus according to claim 5, wherein the degree of opportunity of the conversations between the second person and the third person comprises at least one of a count of the conversations between the second person and the third person, a frequency of the conversations between the second person and the third person, or a count of the third persons involved in the conversations.

10. The information processing apparatus according to claim 6, wherein the degree of opportunity of the conversations between the second person and the third person comprises at least one of a count of the conversations between the second person and the third person, a frequency of the conversations between the second person and the third person, or a count of the third persons involved in the conversations.

11. The information processing apparatus according to claim 7, wherein the degree of opportunity of the conversations between the second person and the third person comprises at least one of a count of the conversations between the second person and the third person, a frequency of the conversations between the second person and the third person, or a count of the third persons involved in the conversations.

12. The information processing apparatus according to claim 8, wherein the degree of opportunity of the conversations between the second person and the third person comprises at least one of a count of the conversations between the second person and the third person, a frequency of the conversations between the second person and the third person, or a count of the third persons involved in the conversations.

13. The information processing apparatus according to claim 1, wherein the speeches and actions between the second person and the third person comprise an action involving the second person and the third person, the action being presumed based on a conversation between the second person and the third person via the network.

14. The information processing apparatus according to claim 2, wherein the speeches and actions between the second person and the third person comprise an action involving the second person and the third person, the action being presumed based on a conversation between the second person and the third person via the network.

15. The information processing apparatus according to claim 13, wherein the action involving the second person and the third person comprises meeting of the second person and the third person.

16. The information processing apparatus according to claim 14, wherein the action involving the second person and the third person comprises meeting of the second person and the third person.

17. The information processing apparatus according to claim 1, wherein the processor is configured to show, to the first person, candidates for a desirable speech or action to be selected by the first person, the candidates being determined based on the degree of progress of the relationship between the second person and the third person.

18. The information processing apparatus according to claim 2, wherein the processor is configured to show, to the first person, candidates for a desirable speech or action to be selected by the first person, the candidates being determined based on the degree of progress of the relationship between the second person and the third person.

19. The information processing apparatus according to claim 17, wherein the processor is configured to rearrange the candidates in desirable order.

20. A non-transitory computer readable medium storing an information processing program causing a computer to execute a process comprising
showing, to a first person among a plurality of persons who make speeches and actions via a network, a degree of progress of a relationship between a second person and a third person, the degree of progress being based on speeches and actions between the second person and the third person, the second person matching the first person, the third person matching the second person.
